(19) United States
(12) Patent Application Publication
(10) Pub. No.: US 2004/0078588 A1
(43) Pub. Date: Apr. 22, 2004

(54) Method and apparatus for balanced electronic operations

(76) Inventors: Stanley T Chow, Nepean (CA); Harold J Johnson, Nepean (CA); James Zhengchu Xiao, Kanata (CA); Miheng Yan, Kanata (CA)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/203,156

(22) PCT Filed: Feb. 19, 2001
(86) PCT No.: PCT/CA01/00199

(30) Foreign Application Priority Data
Feb. 18, 2000 (CA) 2,298,990

(51) Int. Cl. G06F 11/30

(52) U.S. Cl. 713/200

(57) ABSTRACT

As microprocessors and other electronic devices become faster and employ higher component densities, the noise generated by the transitions between data states has an increasing influence on the performance and security of these devices. Calculations and processes performed with the method of the invention will have a constant number of bit transitions, so ground bounce and similar effects are minimized. In the preferred embodiment, this is done by replacing leaky software processes with lookup tables filled with output data corresponding to outputs of a software process indexed with corresponding operand values. The invention is particularly useful in smart card implementations using DES (data encryption standard) protection, which may be cracked by monitoring the power signature while data is being processed.

The present invention relates generally to computer software and electronic hardware, and more specifically, to a method, apparatus and system of performing power balanced electronic operations. A particular implementation is also described which provides resistance to power analysis of sealed platforms, for example, in smart cards employing Data Encryption Standard (DES) protection.

### BACKGROUND OF THE INVENTION

The use of electronic devices is pervasive in industrialized nations. Cellular telephones, cordless telephones, personal computers, personal digital assistants (PDAs), televisions and video cassette recorders (VCRs) are just a few of the many electronic devices that are used every day. The sophistication of these devices and the services they offer is growing continuously, putting greater and greater pressure on the performance requirements of the electronics themselves. In particular, there is pressure to obtain faster processing, higher component densities, and higher levels of security for these devices.

Most of these devices are controlled by a microprocessor, micro-controller, programmable gate array (PGA), application specific integrated circuit (ASIC), digital signal processor (DSP), or similar electronic device with substantial complexity. The power consumed by such a device, or any electronic device for that matter, changes with the state of the electronic components in the device. Such devices generally represent digital data in terms of binary 1s and 0s, which are represented within the electronic device as corresponding high or low voltage levels. For example, a value of 1 may be represented by +5 volts and a value of 0 by 0 volts.

Hence, the amount of power that an electronic device consumes may be correlated with the number of binary is in a data word being processed at a given moment in time. It follows that the amount of current drawn by, and the electromagnetic radiation emanated from an electronic component, may be correlated to the data being manipulated within it. As will be described in greater detail hereinafter, the corresponding power levels can be measured and analysed by attackers to recover secret information.

Even in non-secure applications, this varying level of power consumption presents a problem. Variance in the power consumption causes noise which may cause improper switching of digital components, or noise to be induced in analogue components. This may result in errors or failures in the electronic device itself or in neighbouring devices.

State transitions also affect the power consumption of an electronic device. As the value of a bit changes, transistor switches associated with that bit change state, which may cause a momentary increase in the amount of current drawn. Therefore, there is an increase in the amount of power consumed when the system is in transition. Like the power variances, transition variances also cause noise which may affect device performance or leak information to hostile parties.

Electronic Components in General

Unless precautions are taken, electronic signals can cause standing waves to be induced in the ground plane of the circuit board. For example, when a signal moves from a potential of 0V to 5V, the local potential of the ground plane momentarily rises until the local potential difference dissipates back through the circuit. This rise is referred to as “ground bounce”, “simultaneous switching noise” or “delta-I noise” in the art. Such a rise can cause a reduction in the differential value of other signals in the system, possibly causing some signals with a value of 1 to fall below their threshold values and be interpreted as 0s. As well, because the voltage potential of the ground plane is not uniform throughout the system, electronic components may reach transition levels at different times, causing switching to occur at different times. Poor synchronization of devices may also cause errors to occur.

There is a great deal of pressure on microprocessor and ASIC design teams to improve component performance. Designers are responding by increasing chip power and speed, but these increases aggravate the power management problems. For example, microprocessor performance is being improved by increasing the width of data and address buses. However, as the bus widths increase, the number of signals being switched simultaneously also increases, so there are a larger number of transistor transitions at any given time; the greater the number of simultaneous transitions, the greater the ground bounce.

As well, as microprocessor clock speeds increase, these transitions are being made more often. Therefore, there is less time for these larger currents to charge and discharge through the power and ground buses.

Prior Attempts

The main concentration of efforts to provide balanced power has been by representing data in a “Hamming-neutral” form at the hardware level. The Hamming weight of a binary bit string, such as a data word or byte, is the quantity of bits in the bit string with a value of 1. For example, 10100 will have a Hamming weight of 2, and 1111 will have a Hamming weight of 4. A set of “Hamming-neutral” bit-strings is a set of bit-strings that all have the same number of 1 s. If all of the data bytes manipulated by a software application have the same number of 1s, clearly, the power consumed by the device and the noise it emits will not vary as the device processes this data.

For example, one could replace each “1” in a bit string with a “10”, and each “0” with a “01”. All bit-strings would then have an equal number of 1s and 0s, and theoretically there would be no detectable power or noise variation as these bit-strings are being processed. The benefits of such circuits include:

reduction in noise emissions or induction of cross-talk in other circuits;

reduction in ground bounce. Because power requirements are constant, the voltage of the ground bus does not rise locally when a circuit switches from low to high; and

independence from environmental noise. As both electrical lines in a differential pair are influenced by essentially the same level of environmental noise, there is theoretically no net difference detected at the receiving end.

These techniques are commonly used in military, super computer and industrial control applications. Further information on such techniques is widely available, and includes: Kolodzey J S, CRAY-1 computer technology, IEEE Transactions on Components Hybrids & Manufacturing Technology, Vol. CHMT-4, No. 2, June 1981, pp. 181-6, USA, and Russell R M, The CRAY-1 computer system, Communications of the ACM, Vol. 21, No. 1, January 1978, pp. 63-72, USA.

Hamming-neutral presentation causes all data values to have the same Hamming weight and draw the same amount of power, but there are still problems remaining, for example:

the processing must be changed to be done correctly. For example, the boolean calculation (1 OR 0) would map onto (10 OR 01) using the simple Hamming-neutral coding from above, which could clearly not be effected using the standard OR operator;

as well, the processing must be done without leaking transition power. The processing of data with constant transition power is referred to as Hamming-neutral processing or Hamming-neutral execution. Processing must be done without leakage transition power or the benefit of the Hamming-neutral data presentation would be reduced; and

Hamming-neutral data sets also require the width of all data buses, memory and computational hardware to be increased to handle the new codings. Using the exemplary mapping above, 0-->01 and 1-->10, for example, all of these resources would have to double in capacity. More complex mappings would have a corresponding increase in overhead, for example, the mapping: 0-->0110 and 1-->1001, would require a four-fold increase in resource overhead.

Hence, the software and/or hardware to manipulate Hamming-neutral data is considerably more complex than regular software programming, requiring the creation of new functions to manipulate such abstract codings mathematically.

CRAY computers provide this power balancing at the hardware level, by using ECL (emitter coupled logic). ECL gates provide both a regular output signal and a complementary signal, so the output of each gate will always have a signal with a value of 1, and another with the value of 0. As long as both signals are properly terminated, there will be no change in power consumption as an ECL gate changes state.

However, using ECL gates is an expensive approach that is not practical for most applications. Power consumption is one such consideration, particularly in portable devices such as laptops, cellular telephones and PDAs. The power dissipation of ECL gates is more or less constant, regardless of the state or clock speed, while the power consumption of the leading chips technology, CMOS, varies linearly with the clocking rate. While a CMOS gate is quiescent, it consumes almost no power, while at very high clock rates, its power consumption may equal or exceed that of a comparable ECL circuit. Typically though, electronic components are not running at top speed all the time, so CMOS technology generally results in a very significant power saving.

ECL technology also has several other limitations which make it a poor choice for circuit design, such as its intolerance for variation in power supply voltage. While CMOS components can often operate in a voltage range of ±40% of their design voltage, ECL will only operate in a range of approximately ±10%. This limitation makes it a poor choice for battery powered devices such as mobile telephones and PDAs.

To ensure that proper balancing is provided, small ECL gates must be used, so the designer can confirm that all gates are properly terminated. In fact, an entire CRAY super computer uses only four types of circuits: registers, memory, type D flip-flops and NAND gates, and the above paper published in Communications of the ACM states that: “If a more complex circuit package is used, it is impossible to terminate both sides of every gate.” This design methodology results in very large physical size, and heat management problems which require Freon cooling. Clearly, it is impractical to apply such technologies to today's applications in cellular telephones, digital pagers and PDAs, which must be physically small and consume very little power.

Patent Application Serial No. PCT/US99/12739 by Paul Kocher et al, published as International Publication Number WO99/67766, also attempts to provide a hardware solution to the power balancing problem. Like the CRAY approach, Kocher et al use simple, individual gates to handle the computations, which do not have to ECL. However, the approach of Kocher et al presents similar problems of bulkiness and slow design cycle.

Hardware development languages (HDLs) used to design integrated circuits are logic based, and it is difficult to control the resulting components that will be used to implement a given circuit. Therefore, a standard HDL could be programmed to yield a circuit that provides Hamming-neutral inputs and outputs, but the circuit would not necessarily perform the operations without leaking transition data. A custom HDL would have to be written to fabricate an integrated circuit that implements either of the CRAY or the Kocher methodologies in an efficient way.

The overhead of these added hardware capacities and software complexities generally make the cost of such smart cards too great to be competitive.

Sealed Platforms

As noted above, noise emissions may cause secure information to be leaked to unauthorized parties. Keeping electronic information hidden from hostile parties is desirable in many environments, whether personal, business, government, or military. Recently, “sealed platforms”, which are special kinds of electronic hardware devices, have been developed to satisfy this need. The term “plafform” generally refers to a hardware/software environment capable of supporting computation including the execution of software programs. A “sealed” platform refers to a platform purposely built to frustrate reverse-engineering.

In contrast to traditional credit and debit cards which store a small amount of information on a magnetic strip, the new sealed platforms such as smart cards, may store and process a significantly larger quantity of data using microprocessors, random access memory (RAM), and read only memory (ROM). The new sealed platforms are typically secured using cryptographic technology which is intended to maintain and manipulate secret parameters in open environments without revealing their values. Compromise of a secret key used to compute a digital signature could, for example, allow an attacker to forge the owner's digital signature and execute fraudulent transactions.

A sealed platform is intended to perform its function while protecting information and algorithms, such as performing digital signatures as part of a challenge-response protocol, authenticating commands or requests, and encrypting or decrypting arbitrary data. A smart card used in a stored value system may, for example, digitally sign or compute parameters such as the smart card's serial number, account balance, expiration date, transaction counter, currency, and transaction amount as part of a value transfer.

FIG. 1 presents an exemplary physical structure of a smart card 10, which typically embeds an electronic chip 12 or chips in a plastic card 14. The electronic chip 12 may include, for example, a microprocessor or similar device, read-only memory (ROM), and/or read-write random access memory (RAM). The electronic chip 12 may also include other electronic components such as digital signal processors (DSPs), field-programmable gate arrays (FPGAs), electrically-erasable programmable read-only memory (EEPROM) and miscellaneous support logic.

Generally, the electronic chip 12 is glued into a recessed area 16 of the plastic card 14 and is covered by a printed circuit 18 which provides the electrical interface to an external smart card reader. The standard configuration of the input and output pads of the printed circuit 18 is shown in detail in FIG. 1, and generally includes power (VCC), ground (GND), a clock input (CLK) and a serial input/output pad (I/O). Several additional unconnected pads (N/C) are also included in the standard configuration. Because the plastic card 14 is somewhat flexible, the electronic chip 12 must be small enough to avoid breaking. This limits the physical size of the electronic chip 12 to a few millimetres across, and also limits the number of electronic components that can be supported.

Contactless smart cards are also in use, which communicate with the external smart card reader using radio frequencies or other wireless communication media. Such smart cards are generally equipped with an internal antenna, rather than the input and output pads of the printed circuit 18.

Data Encryption Standard

Smart cards commonly encode their internal data using a cryptographic technique such as the Data Encryption Standard (DES). DES is a block cipher method using a 64 bit key (of which only 56 bits are actually used), which is very fast and has been widely adopted. Though DES can be cracked by a brute-force attack (simply testing all possible keys), triple DES is still considered very secure (triple DES is simply three copies of DES executed in series).

For the purposes of the examples described hereinafter, it is sufficient to know that the DES algorithm performs 16 rounds which effect lookups to eight separate translation tables called S-boxes. A detailed description of the DES is beyond the scope of this discussion, but is presented by Bruce Schneier in Applied Cryptography, 2^{nd} edition, ISBN 0-471-11709-9, 1996, John Wiley & Sons, at pp. 265-294. For the Federal Information Processing Standard (FIPS) description of DES, see FIPS publication 46-3, available on the Internet at http://csrc.nist.gov/fips/.

Other similar cryptographic techniques are also known in the art, including: triple DES, IDEA, SEAL, and RC4; public key (asymmetric) encryption and decryption using RSA and ElGamal; digital signatures using DSA, ElGamal, and RSA; and Diffie-Hellman key agreement protocols. Despite the theoretical strength and complexity of these cryptographic systems, Power Analysis techniques have recently been developed which allow these keys to be cracked quite quickly.

Power Analysis (PA)

Power analysis is the process of gathering information about the data and algorithms embodied on a platform by means of the “power signature” of the platform. The “power signature” of a platform is its power consumption profile measured over time, while executing the software stored on that platform.

As noted above, the power consumed by an electronic device changes with the state of the electronic components in the device. Hence, the amount of power that a sealed platform consumes may be correlated with the number of binary 1s in a data word, at a given moment in time.

Paul Kocher, Joshua Jaffe and Benjamin Jun, in their paper: Introduction to differential power analysis and related attacks, 1998 (available on the Internet at http://www.cryptography.com/dpa/technical), show that attackers can often non-invasively extract secret keys using external measurement and analysis of a device's power consumption, electromagnetic radiation, or processor cycle timing during performance of cryptographic operations. Other similar extraction techniques would be clear to one skilled in the art from the teachings of Kocher et al.

Smart cards, for example, require an external power supply to operate. The current and voltage being supplied to the smart card may easily be monitored while it is executing, using an arrangement such as that presented in FIG. 2. In this arrangement, the smart card 10 is provided with an external power supply unit (PSU) 20, and its operation is monitored using a standard personal computer 22 running appropriate analysis software. The power consumed by the smart card 10 is monitored using a pickup 24, whose data is digitized for the personal computer (PC) 22 using an analogue to digital convertor (A/D) 26. The PC 22 also provides a clock signal (CLK) to the smart card 10 and communicates data via its serial input and output port (DIGITAL I/O). This arrangement allows the attacker to monitor the power consumed by the smart card 10 while it is processing known data.

Simple Power Analysis (SPA)

In simple power analysis (SPA), the power signature for the execution of a given algorithm is used to determine information about the algorithm and its data. Generally, power data is gathered from many executions and averaged at each point in time in the profile.

For example, if SPA is used to attack a DES key space, and the attacker has access to the specific code, but not the particular DES key, a particular series of points in the power signature may indicate the number of 1s and 0s in each 8-bit byte of the DES key (note that the term “byte” will generally refer to an 8-bit byte in this document). This reduces the space of possible keys for an exhaustive all-possible-keys attack from 2⁵⁶ possible keys to 2³⁸ possible keys (if parity bits are stored for each byte of the key), making search time among possible keys about 2¹⁸ times shorter.

Differential Power Analysis (DPA)

Differential power analysis (DPA) is a form of power analysis in which information is extracted by means of gathering multiple power signatures and analysing the differences between them (see Paul Kocher, Joshua Jaffe and Benjamin Jun, 1998, Introduction to differential power analysis and related attacks; available at http://www.cryptography.com/dpa/technical). For certain kinds of data and algorithms exhibiting repetitious behaviour, it is an extraordinarily effective method for penetrating secrets stored on sealed platforms. It can reveal information about the data resulting from computations, fetches from memory, stores to memory, the data addresses in the memory of the sealed platform from which data are fetched or to which data are stored during execution, and the code addresses from which instructions are fetched during the execution of algorithms on the sealed platform. These capabilities render protection of sealed platforms against DPA attack both very important to security and very difficult to achieve on inexpensive sealed platforms.

While SPA attacks use primarily visual inspection to identify relevant power fluctuations, DPA attacks use statistical analysis and error correction techniques to extract information correlated to secret keys. Hence, DPA is a much more powerful attack than SPA, and is much more difficult to prevent.

One use for DPA is to extract cryptographic keys for encryption or decryption performed on a sealed platform. For the Data Encryption Standard (DES), DPA has proved extremely effective; low-cost smart cards performing DES have proven, in recent experience, to be highly vulnerable to DPA. Any form of encryption or decryption which is similar to DES would necessarily have similar vulnerabilities when incarnated on low-cost smart cards or similar sealed platforms.

### DPA EXAMPLE

### Finding a DES Key

Implementation of a DPA attack involves two phases: data collection, followed by data analysis. Data collection for DPA may be performed as described with respect to FIG. 2, by sampling a device's power consumption during cryptographic operations as a function of time or number of clock cycles. For DPA, a number of cryptographic operations using the target key are observed.

To perform such an attack on a smart card, one processes a large number (a thousand or more) DES encryptions (or decryptions) on distinct plaintexts (or cyphertexts), recording:

1. the power profile;

2. the input, chosen at random by the attacker; and

3. the output, computed by the smart card as the encrypted of decrypted value with the hidden key for each.

Each power profile is referred to as a sample.

In each round of DES, the output of a given S-box is dependent on both the data to be encrypted (or decrypted) and the key. Since the attacker knows the input text, he guesses what the value of the key is, that was used to generate a particular power signature sample, so he can determine whether a particular output bit of a given S-box is 1 or 0 for the particular data used in the sample (note that each standard S-box has a 6-bit input and a 4-bit output). Typically, this analysis begins in round 1 or 16 since those are the ones where the attacker knows either the exact inputs (for round 1) or outputs (for round 16) for the respective S-box.

The attacker does not know the key, but because the DES algorithm only performs one S-box lookup at a time, it is only necessary to guess the six bits of the secret key that are relevant to the S-box being observed (and corresponding to the power consumption) at that time. As only 6-bits are relevant, it is only necessary to test 2⁶=64 possible sequences of values for a given 6-bit portion of the 56-bit secret key. For each guess of the values of these six bits, one divides the samples into two groups: those in which the targeted output bit (that is, one of the four output bits from a targeted S-box which is chosen as a target in the first round of the attack) is a 1 if the attacker's guess of the six key bits is correct (the 1-group), and those in which it is a 0 if the attacker's guess of the six key bits is correct (the 0-group).

The power samples in each group are then averaged. On average, modulo minor asymmetries in DES, those portions of the averaged power profiles which are affected only by bits other than the particular output bit mentioned above, should be similar, since on average, in both groups, they should be 1 for about half of the samples in each group, and 0 for about half of the samples in each group.

However, those portions of the averaged power profiles which are affected by the above-mentioned output bit should show a distinct difference between the 1-group and the 0-group. The presence of such a difference, or multiple such differences, indicates that the guessed value of the six key bits was correct. Its absence, or the absence of such differences, shows that the guessed value of the six key bits was incorrect.

This process of guessing at the value of the secret key, dividing the power signature samples into those which will yield a 1-output and those which will yield a 0-output (the 1-group and 0-group respectively), averaging the profiles, and seeking the above-mentioned distinct difference, is repeated until a guess is shown to be correct. One then has six bits of the key.

The above guessing procedure is repeated for the other seven S-boxes. When all S-boxes have been treated in this way, one has obtained 48 out of the 56 key bits, leaving only eight bits undetermined. This leaves a remaining space of 2⁸=256 possible keys to find the balance of the correct secret key.

Note how little information the attacker needs to employ such an attack. The attacker does not have to know:

1. the specific code used to implement DES;

2. the memory layout used for storing the S-boxes;

3. where in the power profile the distinct difference or difference, if any, is expected to appear for a correct guess;

4. how many such distinct differences are expected to appear in the power profile for a correct guess; or

5. whether the chosen S-box output bits are normal or complemented as flipping 1s and 0s will produce the same kind of distinct difference. DPA is only dependent on whether such a difference exists, not in the sign, + or −, of any given difference.

All an attacker really needs to know in order to mount a successful attack is that it is DES which is being attacked, and that the implementation of DES, at some point, employs a bit which corresponds to a specific output of the S-box, in such a way that its use will affect the power profile samples. The paucity of knowledge required to make a successful DPA attack which completely cracks a hidden DES key on a sealed platform clearly shows that DPA is a very effective means of penetrating a sealed platform.

Only one specific form of DPA attack is described herein, but there are many related forms of DPA attacks which are also possible. Other examples of DPA being used to extract a DES key, which demonstrate the extraordinary power of this technique are presented by:

1. Paul Kocher, Joshua Jaffe, and Benjamin Jun, 1998, Introduction to differential power analysis and related attacks, available at http://www.cryptography. com/dpa/technical;

2. Thomas S. Messerges, Ezzy A. Dabbish, and Robert H. Sloan, 1999, Investigations of power analysis attacks on smart cards, Usenix '99, available at http://www.eecs.edu/˜tmesserg/usenix99/htm/paper.html; and

3. Louis Goubin and Jacques Patarin, 1999, DES and differential power analysis: the “duplication” method, Proceedings of CHES '99, Springer Lecture Notes in Computer Science, vol. 1717 (August 1999); available at http://www.cryptosoft.com/html/secpub.htm#goubin.

While the effects of a single transistor switching would be normally be impossible to identify from direct observations of a device's power consumption, the statistical operations used in DPA are able to reliably identify extraordinarily small differences in power consumption.

Physical Protection

Physical measures to protect sealed platforms against attack are known to include: enclosing systems in physically durable enclosures, physical shielding of memory cells and data lines, physical isolation, and coating integrated circuits with special coatings that destroy the chip when removed. While such techniques may offer a degree of protection against physical damage and reverse engineering, these techniques do not protect against non-invasive power analysis methods.

Some devices, such as those shielded to United States Government “Tempest” specifications, use large capacitors and other power regulation systems to minimize variations in power consumption, enclose devices in well-shielded cases to prevent electromagnetic radiation, and buffer inputs and outputs to hinder external monitoring.

These techniques are often expensive or physically cumbersome, and are therefore inappropriate for many applications, particularly smart cards, secure microprocessors, and other small, low-cost, devices. Physical protection is generally inapplicable or insufficient due to reliance on external power sources, the physical impracticality of shielding, cost, and other characteristics imposed by a sealed platform's physical constraints such as size and weight.

Software Protection

As described above, data may be represented in a “Hamming-neutral” form, providing smart cards with a measure of protection against a power analysis attack. However, the shortcomings of Hamming-neutral coding identified above are equally significant in the application to smart cards. That is, Hamming-neutral coding comes at the cost of increases to system resources in the order of 1:2 (for a mapping of 0-->01 and 1-->10) as a minimum, without protecting again the leakage of transitional data. As well, the considerable challenge of designing circuits and components to correctly manipulate the coded data is left unanswered by the art. The overhead of these added hardware capacities and software complexities generally makes the cost of such smart cards too great to be competitive.

Since a normal, unsealed platform is susceptible to attacks potentially more powerful than power analysis (PA), the use of PA in discovery of secret information is primarily directed toward sealed platforms, such as smart cards. However, a simulated power profile of execution can be generated on a simulator for any processor, so it is possible to analyse algorithms for execution on ordinary, unsealed platforms using PA. Hence, although the most urgent need for PA resistance is for use on sealed platforms such as smart cards, PA resistance is required for a much wider variety of platforms.

Improved security is necessary for such devices to be securely used in a broad range of applications in addition to traditional retail commerce, including: parking meters, cellular and pay telephones, pay television, banking, Internet-based electronic commerce, storage of medical records, identification and security access.

There is therefore a need for a method, apparatus and system which provides for proper power balancing of electronic and software systems.

### SUMMARY OF THE INVENTION

It is therefore an object of the invention to provide a method and system which obviates or mitigates at least one of the disadvantages of the prior art.

One aspect of the invention is broadly defined as a method of power balanced execution for a software process, comprising the steps of: replacing leaky software processes with lookup tables filled with output data corresponding to outputs of the process indexed with corresponding Hamming-neutral operand values.

Another aspect of the invention is defined as a method of decreasing externally observable power transitions from execution of a software program on a computer processor, the method comprising the steps of: generating a lookup table to replace the software process by: calculating the output of the software process for each possible set of Hamming-neutral operand values; and storing the output at a location in the lookup table, indexed by the values of corresponding operands.

Another aspect of the invention is defined as an apparatus for processing an algorithm in a manner resistant to external detection of secret information, comprising: means for replacing leaky software processes with lookup tables filled with output data corresponding to outputs of the process indexed with corresponding Hamming-neutral operand values.

Another aspect of the invention is defined as a compiler for compiling high level source code into assembly or machine code comprising the method steps of replacing leaky software processes with lookup tables filled with output data corresponding to outputs of the process indexed with corresponding Hamming-neutral operand values.

Another aspect of the invention is defined as a carrier signal incorporating software code executable to perform the method steps of replacing leaky software processes with lookup tables filled with output data corresponding to outputs of the process indexed with corresponding Hamming-neutral operand values.

An additional aspect of the invention is defined as a computer readable memory medium for storing software code executable to perform the method steps of replacing leaky software processes with lookup tables filled with output data corresponding to outputs of the process indexed with corresponding Hamming-neutral operand values.

A further aspect of the invention is defined as a system for executing the method of replacing leaky software processes with lookup tables filled with output data corresponding to outputs of the process indexed with corresponding Hamming-neutral operand values.

### BRIEF DESCRIPTION OF THE DRAWINGS

These and other features of the invention will become more apparent from the following description in which reference is made to the appended drawings in which:

FIG. 1 presents an exemplary diagram of a smart card as known in the art;

FIG. 2 presents an exemplary physical layout of a system for monitoring and cracking a smart card using power analysis, as known in the art;

FIG. 3 presents a flow chart of a broad method of the invention;

FIG. 4 presents an exemplary Hamming-neutral lookup table in a preferred method of the invention;

FIG. 5 presents a flow chart of a method of bit shifting in a manner of the invention;

FIG. 6 presents a flow chart of a method of bit extraction in a manner of the invention;

FIG. 7 presents a flow chart of a method of bit insertion in a manner of the invention;

FIG. 8 presents the form of a one-dimensional Hamming-neutral address;

FIG. 9 presents the form of a multi-dimensional Hamming-neutral address; and

FIG. 10 presents a memory layout for Hamming-neutral DES implementation.

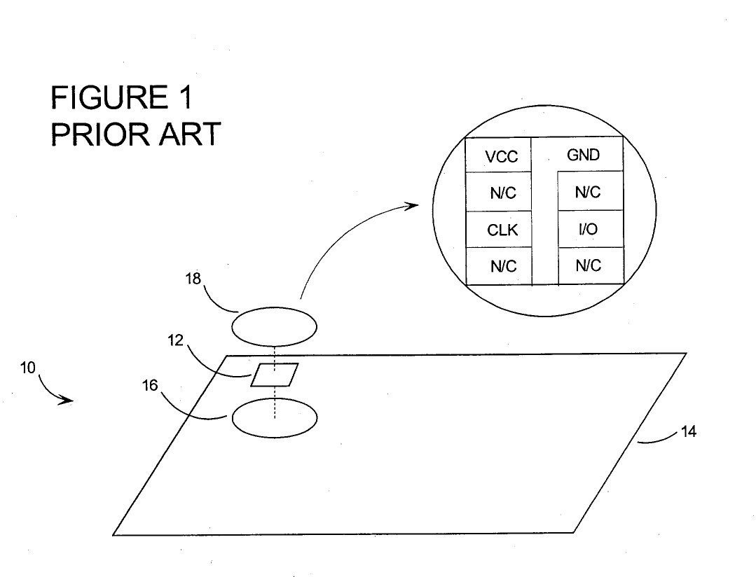

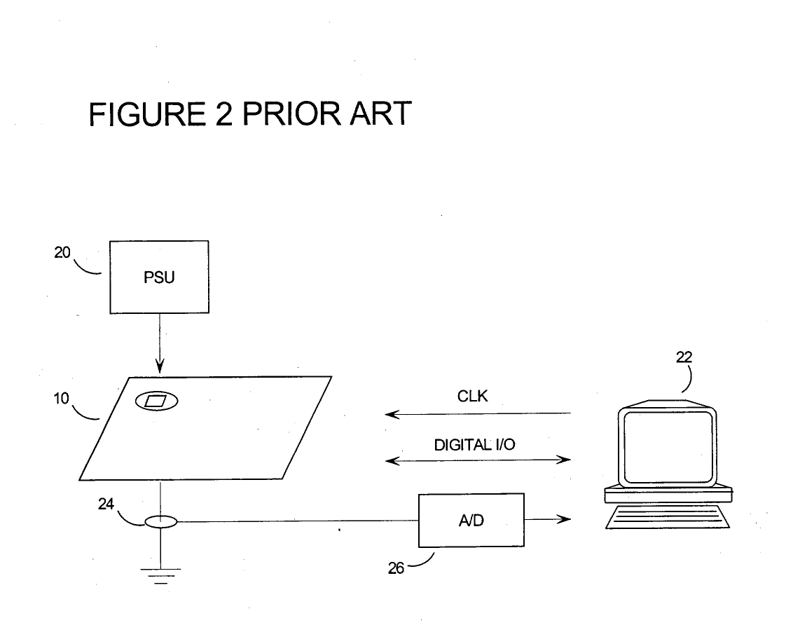

### DESCRIPTION OF THE INVENTION

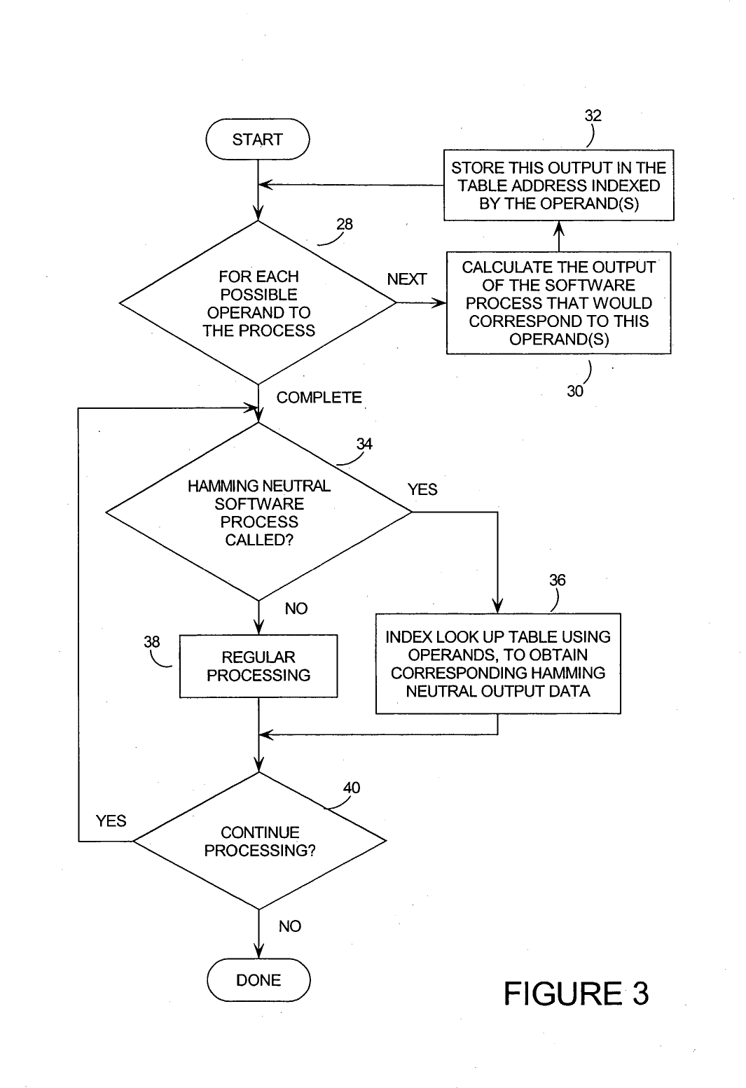

A method which addresses the objects outlined above, is presented as a flow chart in FIG. 3. This method provides transition balanced execution for processes in a software application by replacing a call to the software process, with a lookup table. The values of input operands to the software process are used to index the table, and the stored values in the table, are equal to the output values of the software process. If the indices to the table are Hamming-neutral values, then each access to the table will have the same power signature. If the outputs are Hamming-neutral, then each output will also have the same power signature. Each call to the lookup table and response from it, will have the same signature, so unlike the original software process, no transition leakage occurs.

FIG. 3 presents this method in greater detail. First, the lookup table is generated and stored prior to execution of the actual software application, by executing steps 28 through 32. Step 28 increments through each of the possible operand values for the targeted process, and for each operand value, the corresponding output of the software process is calculated at step 30. This value is stored in the lookup table at step 32 in the location indexed by the operand or operands. Some software processes will have only a single operand, while others will have multiple operands, requiring a multi-dimensional array.

This lookup table will only need entries that will actually be encountered during execution of the software application that is using it, so there may be bounds placed on the range of operand values that allow for more efficient use of memory, or a smaller table. An example of how a sparse lookup table can more efficiently use memory space is given hereinafter.

Lookup tables will typically be generated as part of the compilation of a software application, and will not be generated in an open environment where they might be open to observation by hostile parties. Execution of the software application per steps 34 through 40, will, however, be in an open environment, but are protected against leakage of transition data.

During execution of the software application, when a command is encountered which calls the encoded software process at step 34, the lookup table is indexed at step 36, using the input operands. The output of this lookup, will be the output data of the original software process, that corresponds to the input index data (the operand or operands to the process). If it is determined at step 34 that the called process is a regular process, it is executed at step 38, in the manner known in the art.

If the software processing is determined at step 40 to be complete, the routine ends, otherwise, control returns to step 34 to perform other steps.

The method of the invention described with respect to this flow chart is greatly simplified. It would be clear to one skilled in the art that the actual implementation in a computer of interpreter environment may be for more complex.

As explained in the Background to the Invention herein above, it is desirable to perform software processes without producing power variations. These power variations can cause noise which effects electronic component operation, particular at higher speeds and densities. These power variations can also be monitored by hostile parties and used to easily crack what where thought to be theoretically strong cryptographic methods. One such target for these attacks are smart cards which have very limited resources which can provide protection, and require an external power source which provides an easy avenue for power monitoring. Such power analysis attacks can be used on any manner of software, executing on any manner of microprocessor, micro controller, digital signal processor (DSP), field programmable gate array (FPGA), application specific integrated circuit (ASIC) or the like. Hence, the invention may be useful in many applications.

Mere use of Hamming-neutral data representations is not sufficient to avoid transition count leakage. To avoid transition count leakage of data, addresses, and certain computational operations, one must generally perform computations in accordance with the following general principal:

If two operations are not to be distinguishable by transition count, then they must have the same transition count. Moreover, the number of 1-bits which transition to 0-bits should be the same for the two operations, and the number of 0-bits which transition to 1-bits should both be the same for the two operations. This is feasible in general, either by use of Hamming-neutral table-lookups to implement operations, or by careful implementations using combinations of ordinary computational instructions, or by some combination of these two techniques.

As noted, the number of transitions that take place during the computation can be kept constant. In traditional devices, the number of transitions is a function of the current and/or previous state(s) of the device, including the parameters of the particular computation. Leakless devices can be designed for which the type and timing of state transitions during each part of a computation are independent of the parameters of the computation.

Hamming-neutral execution or processing refers to the execution of basic computations and functions without exposing information to power analysis by either Hamming-weight leakage or transition count leakage. As well, Hamming-neutral execution should not leak information about layout of data tables.

It is very difficult to build complex electronic components which do not leak transition data as many short cuts cause imbalance and preserving power balance means doing things the bulky way. This is why the techniques employed in the Cray computers only used simple gates. Kocher et al also show how to build simple gates in the patent application filed under PCT Serial No. PCT/US99/12739, titled “Balanced Cryptographic Computational Method and Apparatus for Leak Minimization in Smartcards and other Cryptosystems”, which results in a bulky implementation. The method of the invention, using a table lookup, is far more powerful and flexible than those techniques known in the art.

The techniques for Hamming-neutral execution in the manner of the invention, do increase execution time and data storage space. However, in the context of sealed platforms, the overheads they impose are repaid by the protection they provide against power analysis attacks.

From the techniques described herein, it is possible to perform computations such as shifts, additions, boolean, bit-wise boolean, and other operations, in such a way that transition-count leakage and Hamming-weight leakage do not compromise information one wishes to protect.

In addition to describing techniques for Hamming-neutral execution, this disclosure also describes an improved technique for Hamming-neutral encoding of data and addresses. This is described herein as “bit string” encoding, in contrast to the “bit wise” encoding known in the art.

Known techniques for Hamming-neutral encoding result in a major increase in the necessary hardware registers, buses, or locations on a computer, which have a fixed data width in bits (certain unusual architectures excepted). As noted in the Background, a simple mapping of 0-->01 and 1-->10, for example, will require a doubling of all of these resources. Correspondingly, a more complex mapping of: 0-->0110 and 1-->1001, would require a four-fold increase in resource overhead. Such mappings can be described as bitwise mappings.

The method of the invention differs in that mappings are performed in a bitstring manner rather than this bitwise manner. That is, rather than mapping each individual bit onto a new coding which at least doubles the width of all resources, the invention maps groups of more than one bit together onto new Hamming-neutral codings. This results in far more efficient use of resources, and does not require as great an increase in the width of resources.

For example, a Hamming-neutral set of 8-bit strings with exactly four bits having a value of 1, will have 70 members. Therefore, one can encode any 6-bit string onto this 8-bit set, since 2⁶=64<70. The Hamming-neutral encodings known in the art increase the width of resources by ratios of at least 1:2, while in this example, the invention has a ratio of 6 bits (unencoded) to 8 bits (encoded), or 1:1.3

As well, the Hamming-neutral mappings known in the art, such as 0-->01 and 1-->10, or 0-->0110 and 1-->1001, only protect the data with two encodings (one for the 0 bits and one for the 1 bits). In contrast, the method of the invention uses a separate encoding for each bits string, making it far more difficult for an attacker to obtain any useful information. The exemplary 6-bit string, for example, uses 64 encodings.

The Hamming-neutral set must span the set of targeted data, that is, it must have enough members to have at least one entry for each input. Once generated, the members of this Hamming-neutral set may then be mapped onto input bit strings in a one-to-one correspondence.

The use of a one-to-one correspondence results in the smallest Hamming-neutral set, which will have the smallest impact on the system resources. However, it is generally preferable that this mapping be performed on a one-to-many correspondence, that is, a member of the target data set may map onto more than one member of the Hamming-neutral set. This will make decoding by an attacker even more difficult as the observed correspondence between the target data set and the Hamming-neutral set will not be completely consistent. Note that care must be taken when performing the one-to-many mapping, not to overlap the definitions.

Once the targeted data has been mapped onto a Hamming-neutral set, standard software functions and commands may not operate properly. It is therefore necessary to make whatever modifications are necessary to the software program for it to execute in a manner that preserves the logic of the software. A description of the preferred manner of effecting these changes is provided hereinafter, though various extensions and variations would be clear from the teachings herein. The specific changes, of course, depend on the Hamming-neutral mapping and on the functions involved.

Though functions acting on such data would generally have to be modified, there are many applications of the invention which would not require Hamming-neutral calculations to be performed on the Hamming-neutral data, such as personal data which is merely stored or transferred, and static lookups to memory. When indexing memory addresses, data is stored or manipulated, but is not generally processed or altered. In the case of smart cards, the invention may be used to encode the secret key stored on the smart card, so its value cannot be deduced by power analysis during execution.

To summarize, the bitstring Hamming-neutral encoding of the invention:

1. provides Hamming-neutral encoding which is less demanding of system resources than bitwise encoding known in the art;

2. results' in a far greater number of encodings which must be deciphered by an attacker;

3. provides a software based solution which is platform independent, in that it can be applied to a wide variety of platforms;

4. can be applied to various components of the targeted code including, for example: addressing, indexing, stored data or input data, critical applications possibly including all of these encodings; and

5. can be augmented with other techniques described hereinafter, including: fixed prefixes and suffixes, parity bits, Hamming-neutral assemblies, asymmetric implementations, and alphabets.

A more detailed description of the invention now follows.

Hamming-Neutral Sets

Let S be a set of bit-strings. The set S exhibits Hamming-neutrality, or is a Hamming-neutral set, if it has the following properties:

1. |S|>1, where |S| denotes the number of elements in a set S;

2. there exists an integer w>1 such that, for every bit-string xεS, |x|=w, where |x| denotes the length of a string x. That is, all of the bit-strings in the set S have the same number of bits; and

3. there exists an integer h>0 such that, for every bit-string xεS, the number of 1-bits in x is h. That is, each bit-string in the set S has an equal number of bits with a value of 1.

Elements of a Hamming-neutral set are all identical in zero or more bit-positions, whereas two or more elements differ at two or more bit-positions. The bit-positions which are identical for all elements in the set, will be referred to herein as the fixed bit-positions, and the bit-positions which differ between elements in the set, the varying bit-positions. For example, the set S={1010110, 1011001, 1010101} is a Hamming-neutral set of three elements, all of which are bit-strings of length seven. The fixed bit-positions are the leftmost three, and the varying bit-positions are the rightmost four.

If a Hamming-neutral set S is converted to a set T by inserting a parity bit in each member of S, then T is also a Hamming-neutral set provided all of the parity bits are identical. For example, appending odd parity in S yields the Hamming-neutral set T={10101101, 10110011, 10101011} of three elements, all of which are bit-strings of length eight. The fixed bit-positions are the leftmost three and one rightmost; the rest of the bit-positions are varying.

However, use of multiple parity bits which contain parity for different selections of bit-positions, as in error correcting code (ECC), may convert a Hamming-neutral set into one which is not Hamming-neutral. Hence, it is necessary to consider how parity is used on a particular platform in determining whether and where Hamming-neutral sets can be employed on that platform.

For the purpose of the present discussion, it may be assumed that either no parity, or only single-bit even or odd parity, is used, so that any sets of values at a site (that is, in a register, on a bus, or in a location) remain Hamming-neutral whether or not any parity bit is included in the value at that site.

Hamming-neutrality is significant to power analysis resistance because:

1. minor asymmetries of hardware implementation aside, elements of a Hamming-neutral set cannot be distinguished by leakage of Hamming weight information, as they all have the same Hamming weight; and

2. minor asymmetries of hardware implementation aside, when all of the bits of an element of a Hamming-neutral set are transitioned to a specific state (that is, when all bits are transitioned to 0's, or when all bits are transitioned to 1's), then the power signature of this action is identical to the power signature which results when this is done to any other member of the set, since exactly the same number of bits are changed and exactly the same number of bits remain unchanged. Hence, transitional leakage for such operations cannot yield information which could help to distinguish elements of a Hamming-neutral set.

As noted in the items above, asymmetries in the hardware implementation may make power consumption more sensitive to the state, or transitions, of some bits than others. This effect is likely to be minor, but can be guarded against if required. For example, if the implementation is more sensitive to the states and transitions of the high-order and low-order bits in a register than to those in between, one can restrict the Hamming-neutral implementations used to those which fix the first and last bit, and vary only the intervening bits.

In general, one can handle the asymmetric implementation problem by dividing the bits into groups with different sensitivities, and ensuring that, within each group of bits with identical sensitivities, the number of bits set is constant within a given Hamming-neutral representation. As input to this technique, one would need to determine the sensitivities at various bit positions. This may be done for example, by a series of hardware measurements on the target platform.

Size of Hamming-Neutral Sets

The number of ways one can choose a subset of k elements from a set of n elements is the binomial coefficient ₙCₖ. ₙCₖ is read as “n choose k”, and is defined as ₙCₖ=n!/(k!(n−k)!) for positive integers n and k where n≧k.

Let S be a Hamming-neutral set with elements of bit width w, where the elements have m fixed bit-positions and n varying bit-positions (so that w=m+n), and all elements of S have exactly h 1-bits. Therefore, there exists an integer k, where k>1, such that each element of S has exactly k 1-bits in its varying bit-positions. This yields:

|S|≦ₙCₖ, where |S| is denotes the number of elements in a set S.

If |S|=ₙCₖ, then S may be described as a maximal Hamming-neutral set. That is, the set S contains all possible bit strings with n-varying bits, having k 1-bits in the varying bit positions.

A number of terms will now be defined which will aid in the discussion of the techniques which follow.

Population, Spread, and Occupancy

Let H={S₁, S₂, S₃, . . . , Sᵣ}, where r>0, be a set of pairwise disjoint Hamming-neutral sets such that every bit-string in every member of H has the same length, w. H is pairwise disjoint if and only if every pair of distinct elements has an empty intersection; that is, for any i and j such that i≠j, Sᵢ∩Sⱼ=ø. Such a set H is referred to herein as a Hamming-neutral assembly.

That is, all the members of a Hamming-neutral set will have the same Hamming weight. A Hamming-neutral assembly is made of one or more Hamming-neutral sets, each Hamming-neutral set having a different Hamming weight. Therefore, there is no overlap between the different Hamming-neutral sets.

For a Hamming-neutral assembly, H, the population of H is defined to be:

|S₁|+|S₂|+|S₃|+ . . . +|Sᵣ|

that is, the total number of elements in all of the sets in H, because no two elements are the same.

The spread of H is defined to be:

Hₘₐₓ−Hₘᵢₙ+1

where Hₘₐₓ and Hₘᵢₙ are the maximum and minimum values, respectively, of elements of members of H, when the elements are conventionally interpreted as non-negative binary integer values. The occupancy of a Hamming-neutral assembly, H, is defined to be:

(population of H)/(spread of H)

The occupancy is the percentage of available bit strings in a certain range, which are members of the given Hamming-neutral assembly. For example, if Hₘₐₓ=127, Hₘᵢₙ=64, and the Hamming-neutral assembly has 16 members, then the occupancy would be 16/64 or 25%.

For a single Hamming-neutral set, S, one may define the population of S to be the population of H, the spread of S to be the spread of H, and the occupancy of S to be the occupancy of H, where H is the Hamming-neutral assembly {S}.

Performing Operations by Table Lookup

Whenever an operation takes one or more operands whose representations are short, fixed-length bit-strings which use a Hamming-neutral encoding, one can simply create a table with suitable addressing which contains the results for the operation, and index into it by composing a suitable form of Hamming-neutral address, that is, an address from a set of addresses which is a Hamming-neutral set. If the result is to be concealed, one should also use a Hamming-neutral encoding for the data in the table elements. If the operation produces a result which need not be concealed, then the data elements in the table can use an ordinary, non-Hamming-neutral representation.

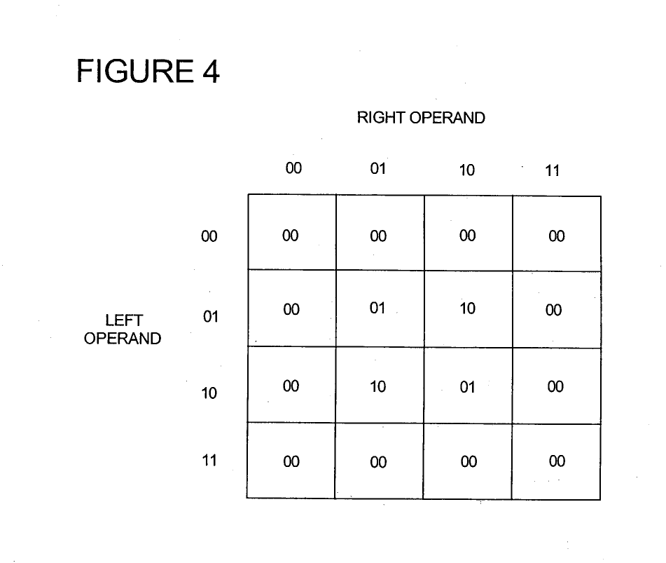

An exemplary XOR (exclusive OR) operation table for a single pair of bit-encoded Boolean values is shown in FIG. 4. This example presents a simple Hamming-neutral mapping of 0-->01, 1-->10; with a high output (10) only when one of the inputs is high. The inputs of 00 and 11, and the outputs of 00 are shown for completeness, but of course, they would not be used.

Almost any kind of operation can be performed by a table lookup, or a sequence of table lookups, based on this technique. For example, since one can add, subtract, or multiply one digit at a time, using multiplication and addition tables, and since these operations are also sufficient for long division, one can do integer arithmetic in a Hamming-neutral way, so that (as long as one is careful to avoid transition count leakage as noted previously) one can perform integer arithmetic on data without leaking any information about that data to power analysis.

Bit-wise Boolean operations can also be performed using tables. For example, a table whose elements are stored as bytes, is sufficient for doing arbitrary binary masking operations on operands encoded in eight bits, but representing six bits.

Shifting can also be done using a table-driven approach. Since one can do Boolean operations as well, one can perform arbitrary computations using the techniques described herein, including floating point computations. These techniques may not be suited to high-speed computation or operation in minimal memory space, however, they are highly suited to execution which is resistant to SPA or DPA attacks.

In its ordinary form, that is, without use of Hamming-neutral methods, DES encryption or decryption involves only the following kinds of operations:

1. bitwise XOR (exclusive OR) operations;

2. selecting and permuting the bits in a string according to a stored table of integers, as in the initial and final permutations, the expansion permutation, and the compression permutation;

3. extraction of a substring within a bit-string; and

4. concatenation of bit-strings.

Bitwise XOR operations can be done by table lookup with a table as shown in FIG. 4, one pair of Boolean operands at a time, so that instead of a 48-bit wide XOR one performs 48 individual XOR operations, handling one bit-position at a time. Selecting and permuting bits, both for wide XOR operations and for other purposes, can also be done by creating appropriate lookup tables. Therefore, the entire DES operation can be performed using the techniques described herein.

Selecting and permuting bits can also be done using the alternative methods described hereinafter. These methods may be desirable wherein there is insufficient memory capacity to store tables for these functions.

### EXAMPLE

### End-Off Logical Shifts

Bit shifting is commonly used in cryptography and in low-level image processing, but may be used in many applications. Of course, a shift of one bit to the left corresponds with multiplying a binary word by two, while a shift of one bit to the right corresponds with dividing by two.

Consider an example: using a simple Hamming-neutral encoding in which one replaces 0 by 01 and 1 by 10, one can represent a 4-bit value in one 8-bit byte. If the platform only provides a left or right logical shift by one bit-position, then some shifts will cause the Hamming weight of the byte to change while other will not. For example, for a left shift, the leftmost bit of the 4-bit value is represented by two bits. Hence, depending on the value of the leftmost represented bit, it is either represented by 01 or 10. As it is shifted end-off, the 01 representation would result in no reduction in Hamming weight followed by a 1-bit reduction, whereas the 10 representation would result in a reduction in 1-bits count followed by no reduction. Thus, transition-count leakage occurs, producing observable differences which could be exploited to obtain some information about the value being shifted.

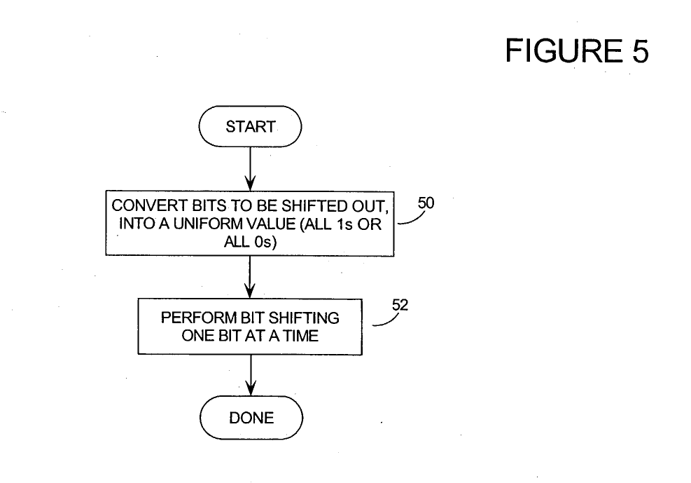

The method of the invention presented in the flow chart of FIG. 5, avoids this transition leakage. The invention converts the bits to be shifted out, into a uniform value (all 1s or all 0s) at step 50, before the shifting is done. This way, each shifting performed at step 52 will cause the same impact on the Hamming weight of the byte, regardless of the initial value of the bits being shifted out. Of course, the operation of converting the bits into the uniform value at step 50, also has a constant power signature.

Continuing with the example above, one could proceed as follows: first, AND the byte with 00111111 (or OR the byte with 11000000), which will produce the same transition count and the same Hamming weights before and after the AND (or before and after the OR), whether the value has 01 or 10 at the left. Then perform the two shifts. Then no transition count or Hamming weight leakage can help to distinguish the value of the represented bit shifted out of the register.

It would be clear to one skilled in the art of assembly- or machine-level programming, with employment of the above techniques and principals, how to compose subroutines for shifting a represented quantity of any width any number of bit-positions, without leaking information about the value being shifted, other than its width and the area of memory used for holding the value to be shifted.

As another example, suppose one needed to encode, in a Hamming-neutral fashion, a 3-position end-off, zero-filled shift of a byte. If the value is bit-encoded, its representation would occupy two bytes, and one must actually shift the 16-bit representation end-off, with 01-pair fill, six positions.

Let us call the left (high order) and right (low order) bytes L and R, respectively. One will use an auxiliary location X (say), and proceed as follows:

1. R←RAND 1100000;

2. repeat six times: shift R right one bit-position;

3. X←L;

4. X←XAND 00111111;

5. repeat twice: shift X left one bit-position;

6. R←R OR X;

7. L=L AND 11000000; and

8. repeat six times: shift L right one bit-position.

This method of computation accomplishes the desired encoded operation and does not leak transition-count or Hamming-weight information about the represented value which is being shifted.

The above method easily extends to arbitrary width shifting operations.

### EXAMPLE

### Extracting a Bit-Field

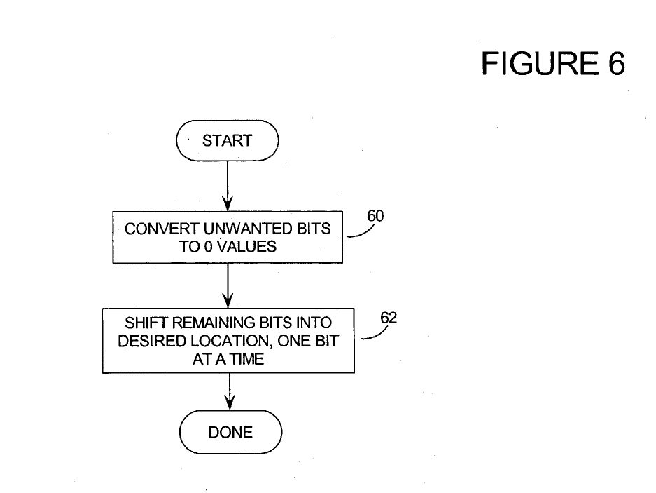

The method of extracting bits builds on the power-balanced shifting technique described above. As per the flow chart of FIG. 6, “unwanted bits” are first converted to 0 values at step 60, which can be done by ANDing the unwanted bits with a 0 value. The remaining bits may then be shifted at step 62 using a single bit shifting operation, to position those bits in the desired location in the word. Of course, bit shifting may be done by more than one bit at a time, if the platform has this facility.

“Unwanted bits” refers to those bits of the original data word which will not appear in the word after extraction. Some of these bits will be shifted out during the shifting step 62, but should still be converted to 0 values at step 60, so that transitional power is not leaked. Of course, the bits being shifted out could also be converted uniformly to values of 1, but this would require a separate operation from the AND operation which is setting other unwanted bits to 0 values.

For example, suppose one has a 12-bit value, and wants to extract the 2-bit field comprising bits eight and nine (numbering from left to right). In a bit-encoded representation, there would actually be 24 bits, and the bit-field would comprise bits 15 through 18 inclusive (numbering from left to right). Hence, the representation would occupy three 8-bit bytes, and the desired field would be represented in the last two bits of the second byte and the first two bits of the third byte.

If one wanted to extract the field in a form suitable for proceeding to a table lookup, one would extract it as a 4-bit representation with four high-order 0-bits prepended to make a one-byte value. One would do this as follows, calling the bytes L (left), M (middle), and R (right), respectively, and using auxiliary locations X and Y:

1. X←M AND 00000011;

2. repeat twice: shift X left one bit-position;

3. Y→R AND 11000000;

4. repeat six times: shift Y right one bit-position; and

5. X←X OR Y.

If one wanted instead to extract the field in a form providing a one-byte bit-encoded representation, one would add the following step:

6. X←X OR 01010100.

This step prepends the needed bit-encoded representation of the three leading 0-bits (each 0 represented as 01).

If one wanted to produce a longer representation, one would prepend entire bytes containing 01010101.

The method described here avoids transition-count and Hamming-weight leakage of information about the data values being manipulated and the data values resulting from the computations.

### EXAMPLE

### Inserting a Bit-Field

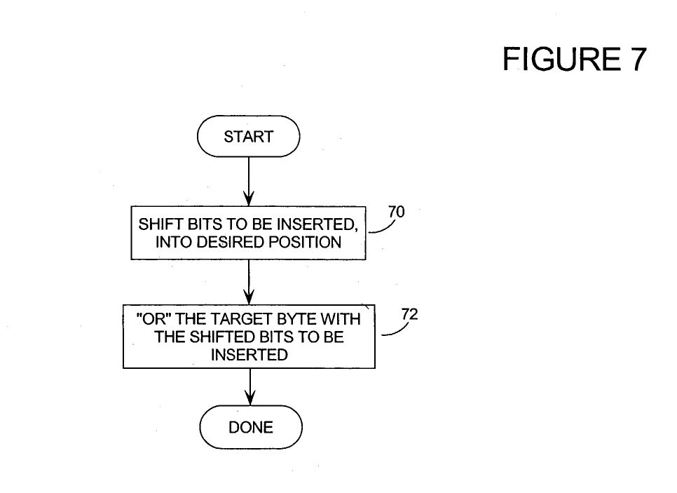

The method of inserting bits also builds on the power-balanced shifting technique described above. As per the flow chart of FIG. 7, the bits that one wishes to insert into a target byte, are first shifted into the desired position at step 70. If this shifting causes some nonuniform data to be shifted out, than a previous step of setting such bits to a uniform value, would have to be performed. As noted above, this could be done by AND-ing the bits to be shifted out with 0 values (making them all 0 values), or OR-ing them with 1 values (making them all 1 values). At step 72, the target byte is then OR-ed with the shifted bits to be inserted. If any of these bit positions in the target byte have non-0 values, then these positions will have to be set to 0 values in a previous step, by AND-ing them with 0 values.

This process becomes a little more complicated with larger data words. Suppose for example, one has a 12-bit value, and wishes to insert a 2-bit field comprising bits eight and nine (numbering from left to right). In a bit-encoded representation, there would actually be 24 bits, and the bit-field would comprise bits 15 through 18 inclusive (numbering from left to right). Hence, the representation would occupy three bytes, and the desired field would be represented in the last two bits of the second byte and the first two bits of the third byte.

One would do this as follows, calling the bytes L (left), M (middle), and R. (right), respectively, with the value to be inserted into the field represented in another byte V (the data to be inserted laying at bit locations 5 through 8), and using auxiliary locations X and Y:

1. X←V;

2. Y←X AND 00000011;

3. repeat six times: shift Y left one bit-position;

4. X<-X AND 00001100;

5. repeat two times: shift X right one bit-position;

6. M<-M OR X; and

7. R<-R OR Y.

The method described here avoids transition-count and Hamming-weight leakage of information about the data values being manipulated and the data values resulting from the computations.

Hamming-Neutral Addressing

Hamming-neutral addressing is performed by employing selected Hamming-neutral sets or assemblies. Hamming-neutral assemblies are used for sets of addresses which divide into more than one subset, where the distinctions among the subsets need not be protected.

One Dimensional Hamming-Neutral Addressing

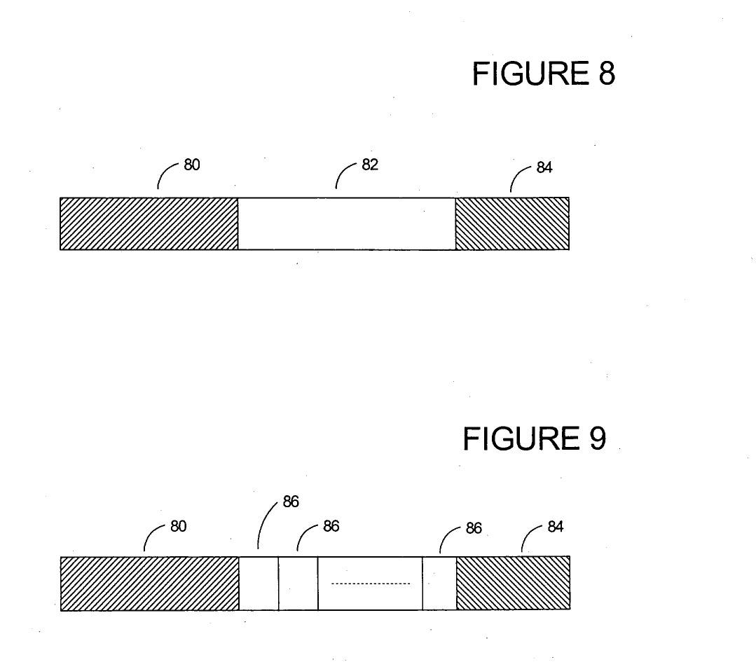

A typical construction for one-dimensional Hamming-neutral addressing is shown in FIG. 8, following the usual convention that high-order bits are on the left and low-order bits are on the right. If the Hamming-neutral addressing is based on a Hamming-neutral set, then for each such address, the varying bit-positions contain the same number of 1-bits. If it is based on a Hamming-neutral assembly, then the varying bit-positions contain different quantities of 1-bits, depending on how many Hamming-neutral sets of addresses have been mapped onto the same region of memory. Note that the pairwise disjointness of the members of a Hamming-neutral assembly guarantees that storage elements based on distinct sets from the assembly have distinct addresses, that is, there is no possibility of two elements of data being stored in the same place.

The prefix bit-positions 80 contain fixed bit-values which determine the region of memory to be addressed. The use of such prefixes is well known in the art.

The maximum width of the addressed memory region is the spread of any underlying maximal Hamming-neutral set or Hamming-neutral assembly. The number of elements which could be stored in the memory region is the population of the set or assembly. The fraction of the region which is actually usable for Hamming-neutral addressing is the occupancy of the set or assembly. Definitions for spread, population, and occupancy are given herein above.

One may fine-tune the positioning of the variable bits 82 by appropriate selection of the suffix fixed bit-positions 84, which provide an offset. Often these suffix bits 84 would contain only zeros, since it is often convenient to store an item in b bits in such a way that its first address modulo 2^{b} is 0 (2-byte items on even boundaries, 4-byte items on modulo 4 boundaries, and so on). The width of the string of suffix fixed bit-positions 84 determines the width, in memory units, of the storage per element. If it is s, then the space provided for each value to be fetched or stored is 2^{s} memory units. The width of the entire address, that is, the total number of bit positions, is determined by the type of memory to be addressed and the characteristics of the platform.

Plainly, given the ability to do Hamming-neutral shifting and masking as noted above, addresses can be composed in the form of FIG. 8 as required.

Multiple Dimensions

A typical construction for multi-dimensional Hamming-neutral addressing is shown in FIG. 9. The prefix 80 and suffix 84 fixed bit-positions are as before, with the prefix 80 selecting the region of memory and the suffix 84 an offset.

If d-dimensional indexing is required, then there are d contiguous groups of varying bit-positions 86, with widths w₁, w₂, . . . , w_{d}, where each wᵢ is chosen so that one can find at least nᵢ distinct index values which fit in wᵢ bits, allowing representation of a simple table with an ith index range of nᵢ entries.

Again, using shifting and masking techniques, one will be able to compose addresses of the above multi-dimensional form as needed. Note that care is required so that during the composition, all intermediate results are Hamming-neutral. This is easily accomplished by zeroing the whole address, then adding each component to it using an OR operation.

### AN EXTENDED EXAMPLE

### Hamming-Neutral Implementation for DES

A way of implementing the invention upon secret keys under the Data Encryption Standard is now described. The Data Encryption Standard (DES), is described in FIPS publication 46-3, available at http://csrc.nist.gov/fips/ and is both described and extensively discussed on pp. 265-294 of Bruce Schneier's Applied Cryptography, 2^{nd} edition, ISBN 0-471-11709-9, 1996, John Wiley & Sons.

Application to DES Key Representation

For the sake of simplicity, 56-bit DES keys are represented in this example in bit-encoded form, where 0 is represented by 01 and 1 by 10, rather than in bit-string encoded format. Implementations in bit-string format would follow logically from the description which follows.

Note that this exemplary mapping doubles the storage for a key from seven bytes to 14 bytes. Parity bits are omitted from the representation, since on a smart card, the keys would be fixed data stored in ROM.

S-Box Representation

According to the DES standard, an S-box contains 64 4-bit entries. Since the output bits of an S-box are dealt with individually, a bit-encoded representation (such as 0->01 and 1->10 for example) may be used for elements of the S-boxes also. This puts one S-box entry in one byte. Since 8-bit processors are typical for smart cards, this is a convenient representation for smart card implementations.

However, if a bit-encoded representation for the varying bits within the S-box addresses is used, each S-box will consume too much address space. To avoid this, it is preferable to perform a two-stage lookup that employs one large access table.

The S-box Access Table

Ordinarily, an S-box index occupies six bits, so using a simple bit-encoded representation of 0->01 and 1->10, it will occupy twelve bits. This twelve-bit index means that the naive table will consume 4 K bytes of memory (2¹²=4096). In the preferred embodiment, a conversion is performed to reduce the storage space required for this table into 256 bytes (256=2⁸).

To do this, one index conversion table (the S-box access table) is employed, which converts a 12 bit, bit-encoded S-box index into an 8 bit, bit-string encoded S-box element address, and is used once each time an element is fetched from an S-box. It is indexed by a Hamming-neutral address in which there are no suffix fixed bit-positions, there are twelve varying bit-positions in the form of such a twelve-bit bit-encoded index, and the prefix bit-positions indicate the region of memory containing this index conversion table. Indexing into this table with a 12-bit bit-encoded index, the addressed data byte is a corresponding 8-bit index containing some arrangement of four 1-bits and four 0-bits. This 8-bit index is then used to lookup the actual S-box. Note that each step of this process is Hamming-neutral.

Memory Layout

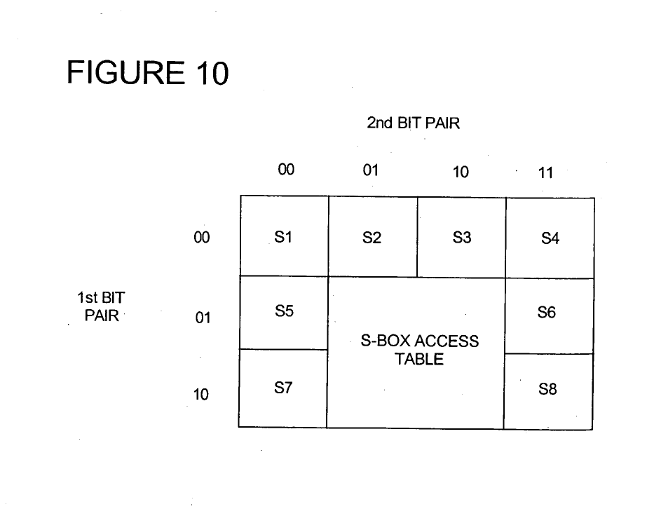

The memory region in which the conversion table lies may now be considered. FIG. 10 presents an exemplary layout of such a memory region.

The region of memory indicated in FIG. 10 begins on a 4K boundary, that is, on a 2¹² boundary. This diagram presents regions of memory in terms of blocks of 256 bytes. The first two bits of the index can only be 01 or 10, and the second two bits of the index can only be 01 or 10, thus the last 1K of the 4K region starting at the 4K boundary can be unused. Moreover, the 1K portion which begins the region is unused, and can provide space for four 256-byte S-box representations, and four 256 byte regions beginning with 0100, 1000, 0111, and 1011, are also unused, providing space for another four 256-byte S-box representations. Hence, the entire eight S-boxes, and the conversion table described in the previous section, can all be stored in a 3K region beginning at a 4K boundary with a good deal of space still unoccupied.

In FIG. 10, S-boxes 1 through 8 appear as S₁ through S₈, respectively. Each S-box occupies only a sparse portion of its 256 bytes, since only 64 of the 256 bytes are actually used to contain bit-encoded S-box entries. Their occupancy is therefore 25%.

The S-box access table sparsely occupies four 256-byte blocks, since only 64 out of 1024 of the bytes are occupied by the result of translation from bit-encoded to an ₈C₄ Hamming-neutral representation. Its occupancy is thus 6.25%.

For example, if a data value of 011001 was to be looked up in an S-box during the course of execution, it will have a 12-bit, bit-encoded representation of 011010010110 (using the simple mapping of 0-->01 and 1-->10). Indexing the table of FIG. 8 using this value, the 1st and 2^{nd} bit pairs will index the S-box access table. The data obtained will be an 8-bit, Hamming-neutral value. The program will then append a 4-bit prefix to this value, depending on which S-box is to be accessed at this point in the DES program. When the table is accessed with this 12-bit value, the desired S-box will be accessed and the data obtained.

Effect of Applying the Invention

The implementations according to the instant invention are protected against both SPA and DPA by one or more of the following:

1. removal of features or differences in power profiles, both individual and averaged, by use of computational methods which avoid many situations in which power features or differences would otherwise be expected; and

2. removal of differences between averaged power profiles, by use of computational methods which render such profiles statistically neutral, on average, where they would ordinarily be expected to show distinct differences.

With the comprehensive application of the invention, input and output data from S-box lookups, and the incoming operands and results of all XOR operations and permutations, bit-selections, and the like, are all concealed. Since all computations will be Hamming-neutral, all executions will have the same number of 1 bits and the same number of 0 to 1 and 1 to 0 transitions. This assures that each power trace is the same (except for the hardware asymmetry). Thus, all aspects of the DES key are concealed against power-analysis attacks.

The techniques provide protection against revealing any or all of: the data, the data addresses, and the code addresses employed during execution.

Combined Execution Methods

Any of the techniques described herein could be combined with any of the Hamming-neutral data encoding techniques of the co-pending PCT Patent Application Serial No. ______, titled: “Method and System for Resistance to Statistical Power Analysis”, including the average-neutral, permuted, or code-padding execution. These techniques could also be implemented with the Hamming-neutral representations presented in the co-pending patent application Ser. No. ______, titled: “Encoding Method and System Resistant to Power Analysis”. Greater protection is obtained by using more of these methods at the same time.

In addition, the above methods may be combined, individually or severally, with the methods of producing tamper-resistant, secret-hiding software described in the co-pending data flow patent application, U.S. patent application Ser. No. 09/329,117, filed Jun. 9, 1999, titled: “Tamper Resistant Software Encoding”, the co-pending control flow patent application, U.S. patent application Ser. No. 09/377,312, filed Aug. 19, 1999, titled: “Tamper Resistant Software—Control Flow Encoding”, and the co-pending Canada Patent Application, Serial No. 2,305,078, filed Apr. 12, 2000, titled: “Tamper Resistant Software—Mass Data Encoding” to provide a still greater range of protection for a program. Different subsets of the above methods may also be used for different parts of the same program to be protected, depending on the degree of protection with which one wishes to provide each different part.

These techniques may also be combined with other security techniques known in the art such as physical protection or noise introduction, though some of the advantages of the invention may be compromised.

While particular embodiments of the present invention have been shown and described, it is clear that changes and modifications may be made to such embodiments without departing from the true scope and spirit of the invention.

It is understood that as attacking tools become more and more powerful, the degree to which the techniques of the invention must be applied to ensure an adequate level of security, will also rise. It is understood, therefore, that the utility of some of the simpler claimed techniques may correspondingly decrease over time. One skilled in the art would appreciate this and apply the invention accordingly.

The method steps of the invention may be embodied in sets of executable machine code stored in a variety of formats such as object code or source code. Such code is described generically herein as programming code, or a software program for simplification. Clearly, the executable machine code may be integrated with the code of other programs, implemented as subroutines, by external program calls or by other techniques as known in the art.

Because some aspects of the instant invention require precise control over instructions used in algorithms and data layouts in memory, the instant invention is most applicable to assembly- or machine-level implementations. It is less applicable to high-level language (HLL) implementation, because compilers for HLLs usually do not provide the programmer with sufficient control over instruction and memory usage to permit the instant invention to be used effectively.

However, it is possible to employ some or all of the techniques of the instant invention in code generation by a compiler for some HLL. Such a compiler could then be employed to generate PA-resistant machine-code or assembly-code from source-code written in the HLL.

There are many uses for software applications which embed and employ a secret encryption key without making either the cryptographic key or a substitute for the cryptographic key available to an attacker. The method of the invention can generally be applied to these applications.

The embodiments of the invention may be executed by a computer processor or similar device programmed in the manner of method steps, or may be executed by an electronic system which is provided with means for executing these steps. Similarly, an electronic memory medium may store code executable to perform such method steps. Suitable memory media would include serial access formats such as magnetic tape, or random access formats such as floppy disks, hard drives, computer diskettes, CD-Roms, bubble memory, EEPROM, Random Access Memory (RAM), Read Only Memory (ROM), optical media, or magneto-optical media or similar computer software storage media known in the art. Furthermore, electronic signals representing these method steps may also be transmitted via a communication network.

The invention could also be implemented in hardware, or a combination of software and hardware including software running on a general purpose processor, microcode, PLAs, ASICs, and any application where there is a need for leak-minimized cryptography that prevents external monitoring attacks.

It will be clear to one skilled in these arts that there are many practical embodiments, of the DES implementation produced by the instant invention, whether in normal executable machine code, code for a virtual machine, or code for a special purpose interpreter. It would also be possible to directly embed the invention in a net-list for the production of a pure hardware implementation, that is, an ASIC.

Typically, the methods and apparatuses of the present invention might be embodied as program code running on a processor, for example, as instructions stored on in the memory of a smart card. Where greater security is desired, the code might additionally be signed by a trusted party, for example, by the smart card issuer. The invention might be embodied in a single-chip device containing both a nonvolatile memory for key storage and logic instructions, and a processor for executing such instructions.

It would also be clear to one skilled in the art that the invention need not be limited to the described scope of credit, debit, bank and smart cards. An electronic commerce system in a manner of the invention could for example, be applied to: point of sale terminals; vending machines; cryptographic smart cards of all kinds including contactless and proximity-based smart cards and cryptographic tokens; stored value cards and systems; electronic payment, credit and debit cards; secure cryptographic chips, microprocessors and software programs; pay telephones, prepaid telephone cards, cellular telephones, telephone scrambling and authentication systems; security systems including: identity verification systems, electronic badges and door entry systems; systems for decrypting television signals including broadcast, satellite and cable television; systems for decrypting enciphered music and other audio content (including music distributed over computer networks); and systems for protecting video signals. Such implementations would be clear to one skilled in the art, and do not take away from the invention.

We claim:

1. A method of power balanced execution for a software process, comprising the steps of:
replacing leaky software processes with lookup tables filled with output data corresponding to outputs of said process indexed with corresponding Hamming-neutral operand values.

2. A method of decreasing externally observable power transitions from execution of a software program on a computer processor, said method comprising the steps of:
generating a lookup table to replace said software process by:
calculating the output of said software process for each possible set of Hamming-neutral operand values; and
storing said output at a location in said lookup table, indexed by the values of corresponding operands.

3. The method of claim 2, further comprising the step of:
responding to calls to said software process during execution, by:
indexing said lookup table using input Hamming-neutral operands, to obtain said corresponding output data.

4. A method of transition balanced execution of a software application having at least one software process, comprising the steps of:
generating and storing a lookup table to replace said software process said table having:
indices for all possible Hamming-neutral inputs to said software process; and
addressed data for outputs of said given software process at corresponding indexed locations; and
during execution of said software application, responding to calls to said software process by:
indexing said lookup table using input operands to obtain said corresponding output data.

5. The method of claim 4, wherein said output data is Hamming-neutral output data.

6. A method of transition balanced execution of a software application having at least one software process, comprising the steps of:
generating and storing a lookup table having:
indices for all possible Hamming-neutral inputs to said software process; and
addressed data for Hamming-neutral outputs of said given software process at corresponding indexed locations; and
during execution of said software application, responding to calls to said software process by:
indexing said lookup table using input operands to obtain said corresponding Hamming-neutral output data.

7. A method of software execution without revealing information due to Hamming weight leakage or transition count leakage, said method comprising the steps of:
replacing leaky software processes with lookup tables indexed with Hamming-neutral operand values for each process, and having data fill corresponding to outputs of said software process

8. A method of avoiding transition count leakage during execution of masking operations comprising the steps of initially setting affected fields to all 0-bits or all 1-bits, thereby preventing power feature distinctions from being observed during transitions from one state to another.

9. The method of claim 6, further comprising the steps of:
indexing a portion of said table referred to an access table, to obtain indices to access a second portion of said table to obtain output data.

10. The method of claim 1, further comprising the steps of:
in a sparse table, appending fixed values to said output, to access different portions of said table.

11. The method of claim 1, further comprising the steps of:
accessing said table using a Hamming-neutral bit-encoded index, to obtain a second index which is not a defined value in the set of said Hamming-neutral bit-encoded values.

12. The method of claim 1, further comprising the steps of:
accessing said table using a 12-bit Hamming-neutral bit-encoded index, to obtain an 8-bit Hamming-neutral bit-string encoded index;
appending a 4-bit prefix to said 8-bit Hamming-neutral bit-string encoded index; and
accessing said table using said 4-bit prefix appended to said 8-bit Hamming-neutral bit-string encoded index, to obtain an S-box output.

13. The method of claim 18, further comprising the steps of:
bit shifting a data word to position index data by:
masking index data by converting bits to be shifted out into predictable (uniform, either are 1s or all 0s) form; and
performing single bit shifts as required to locate said index data in said data word;
whereby said step of masking is transition constant for any possible input as all bits strings are Hamming-neutral, and said step of perform is transition constant as all bits to be shifted out are the same value, for all possible inputs.

14. The method of claim 18, wherein said step of masking comprises the step of ANDing the data word with 0 values, whereby the product is 0 for all cases.

15. The method of claim 18, wherein said step of masking comprises the step of ORing the data word with 1 values, whereby the product is 1 for all cases.

16. The method of claim 1, further comprising the steps of:
generating a Hamming-neutral set sufficient to span a set of targeted bit strings; and
assigning each member of said set of targeted bit strings to a member of said Hamming-neutral set.

17. The method of claim 3 further comprising the step of:
executing said software program with consideration for said Hamming-neutral set assignment, preserving the logic of said software program.

18. The method of claim 3 wherein said step of assigning is performed in a one-to-one correspondence.

19. The method of claim 3 wherein said step of assigning is performed in a one-to-many correspondence.

20. The method of claim 3 wherein said set of targeted data comprises a set of addresses.

21. The method of claim 3 wherein said set of targeted data comprises a set of data.

22. The method of claim 6 wherein the ratio of the bit length of said set of targeted bit strings to the bit length of said Hamming-neutral set is less than 1:2.

23. The method of claim 6, wherein said targeted data comprises addressing for indexed data.

24. The method of claim 6, comprising the steps of generating a Hamming-neutral set comprising a fixed field and a variable field.

25. The method of claim 16, wherein said fixed field comprises a fixed prefix to define a region of memory.

26. The method of claim 16, wherein said fixed field comprises a fixed suffix to define a memory offset.

27. A method of end-off shifting comprising the steps of:
converting the bits to be shifted out, into a uniform value (all 1s or all 0s); and
shifting said bits to be shifted out.

28. A method of end-off shifting comprising the steps of:
setting R←R AND 1100000; where the left (high order) and right (low order) bytes L and R, respectively, and an auxiliary location X is used,
repeating six times: shift R right one bit-position;
setting X←L;
setting X←X AND 00111111;
repeating twice: shift X left one bit-position;
setting R←R OR X;
setting L=L AND 11000000; and
repeating six times: shift L right one bit-position.

29. A method of extracting bits comprising the steps of:
converting bits which should not appear in the output byte, to 0 values; and
shifting remaining bits to position those bits in the desired location in the word.

30. A method of extract a field in a form suitable for proceeding to a table lookup, extracting a 4-bit representation with four high-order 0-bits prepended to make a one-byte value, said method comprising the steps of:
setting X←M AND 00000011; where the bytes L (left), M (middle), and R (right) are 8 bit bytes of the data word, and using auxiliary locations X and Y;
repeating twice: shift X left one bit-position;
setting Y←R AND 11000000;
repeating six times: shift Y right one bit-position; and
setting X←X OR Y; and
response to the requirement to extract the field in a form providing a one-byte bit-encoded representation, setting X←X OR 01010100, thereby prepending the needed bit-encoded representation of the three leading 0-bits (each 0 represented as 01).

31. A method of inserting bits comprising the steps of:
shifting the bits that one wishes to insert into a target byte, into the desired position; and
OR-ing the target byte with the shifted bits to be inserted.

32. A method of inserting bits comprising the steps of:
setting X<--V, where the bytes L (left), M (middle), and R (right), are respective 8 bit bytes of the data word, the value to be inserted into the field is represented as byte V, and using auxiliary locations X and Y;
setting Y<--X AND 00000011;
repeating six times: shift Y left one bit-position;
setting X<--XAND 00001100;
repeating two times: shift X right one bit-position;
setting M<-M OR X; and
setting R<-R OR Y.

33. A method of decreasing noise from execution of a software program on a computer processor, comprising the steps of:
assigning each member of a set of targeted bit strings, in a one-to-one correspondence, to a member of a Hamming-neutral set of data, said Hamming-neutral set of data being sufficient to span said set of targeted bit strings; and
executing said software program in accordance with said Hamming-neutral set assignment, preserving the logic of said software program.

34. An apparatus for processing an algorithm in a manner resistant to external detection of secret information, comprising:
means for replacing leaky software processes with lookup tables filled with output data corresponding to outputs of said process indexed with corresponding Hamming-neutral operand values.

35. A compiler for compiling high level source code into assembly or machine code comprising the method steps of any one of claims 1 through 15.

36. A carrier signal incorporating software code executable to perform the method steps of any one of claims 1 through 15.

37. A computer readable memory medium for storing software code executable to perform the method steps of any one of claims 1 through 15.

38. A system for executing the method of any one of claims 1 through 15.
